(19) United States
(12) Patent Application Publication
(10) Pub. No.: US 2009/0066637 A1
(43) Pub. Date: Mar. 12, 2009

(54) HANDHELD ELECTRONIC DEVICE WITH MOTION-CONTROLLED DISPLAY

(75) Inventor: CLARK E. MC CALL, ANN ARBOR, MI (US)

Correspondence Address: INGRASSIA FISHER & LORENZ, P.C. (GM), 7010 E. COCHISE ROAD, SCOTTSDALE, AZ, 85253, US

(73) Assignee: GM GLOBAL TECHNOLOGY OPERATIONS, INC., DETROIT, MI (US)

(21) Appl. No.: 11/853,693

(22) Filed: Sep. 11, 2007

(51) Int. Cl. G09G 5/00; G08B 21/00

(52) U.S. Cl. 345/156; 340/669

(57) ABSTRACT

A handheld electronic device includes a display, a memory configured to store a map, and a motion sensor configured to monitor the movement of the handheld electronic device. A controller is coupled to the display, the memory, and the motion sensor. The controller is configured to generate an image on the display representative of a portion of the map, the image having a field of view (FOV). The controller is also configured to adjust the FOV of the image based upon the movement of the handheld electronic device as detected by the motion sensor.

### TECHNICAL FIELD

The present invention generally relates to portable display devices and, more particularly, to a handheld electronic device (e.g., a keyfob) having a display controlled by device movement.

### BACKGROUND

It is becoming relatively common for handheld display devices (e.g., personal digital assistants (PDAs)) to store and display navigational maps. A generalized handheld electronic device might include a display (e.g., a liquid crystal display), an externally-mounted user input control (e.g., a group of buttons and/or a cursor device), and a controller having a memory that stores a library or database of maps. During operation of the device, a user may utilize the user input control to select a desired map from the library of maps. An image is then generated on the device's display representative of the selected map. However, due to the size and resolution of the display, it is often the case that the entire map cannot be clearly produced on the device's display at one time. Therefore, the generated image may have a field of view (FOV) that encompasses only a portion of the stored map. The user may then manipulate the FOV of the display utilizing the device's input control to explore the entire map, portion by portion. For example, a user may utilize the user input control to scroll the FOV of the image upward, downward, to the left, and to the right and to adjust the scale of the FOV (i.e., to zoom in and out) as desired.

Handheld display devices that require the manual manipulation of an externally-mounted user input control to adjust the display's FOV may be limited in certain respects. For example, the externally-mounted user input control may occupy a relatively large amount of space on the device's exterior that might otherwise accommodate a larger display screen or additional user inputs. Furthermore, the manner in which such externally-mounted user input controls are utilized to manipulate the display's FOV may not be intuitive to some users.

In view of the above, it is desirable to provide a handheld portable electronic device (e.g., a PDA, a keyfob, etc.) that includes a means for manipulating the FOV of a map image that is intuitive and that overcomes the disadvantages described above. Other desirable features and characteristics of the present invention will become apparent from the subsequent detailed description and the appended claims, taken in conjunction with the accompanying drawings and the foregoing technical field and background.

### SUMMARY

A handheld electronic device includes a display, a memory configured to store a map, and a motion sensor configured to monitor the movement of the handheld electronic device. A controller is coupled to the display, the memory, and the motion sensor. The controller is configured to generate an image on the display representative of a portion of the map, the image having a field of view (FOV). The controller is also configured to adjust the FOV of the image based upon the movement of the handheld electronic device as detected by the motion sensor.

### DESCRIPTION OF THE DRAWINGS

The present invention will hereinafter be described in conjunction with the following drawing figures, wherein like numerals denote like elements, and:

FIG. 1 is a block diagram of a keyfob having a motion-controlled display in accordance with a first exemplary embodiment;

FIGS. 2 and 3 are plan views of the keyfob shown in FIG. 1 displaying an exemplary graphical menu structure and map view, respectively;

FIG. 4 is a map that may be displayed, in portions, on the display of the keyfob shown in FIGS. 2 and 3 illustrating three field of views (FOVs) each having a different scale;

FIG. 5 is a map that may be displayed, in portions, on the display of the keyfob shown in FIGS. 2 and 3 illustrating five FOVs having the same scale;

FIG. 6 is an isometric view of the keyfob shown in FIGS. 2 and 3 illustrating a first set of motions that may be utilized to transition between the FOVs shown in FIGS. 4 and 5; and

FIG. 7 is an isometric view of the keyfob shown in FIGS. 2 and 3 illustrating a second set of motions that may be utilized to transition between the FOVs shown in FIG. 5.

### DESCRIPTION OF AT LEAST ONE EXEMPLARY EMBODIMENT

The following detailed description is merely exemplary in nature and is not intended to limit the invention or the application and uses of the invention. Furthermore, there is no intention to be bound by any expressed or implied theory presented in the preceding technical field, background, brief summary, or the following detailed description.

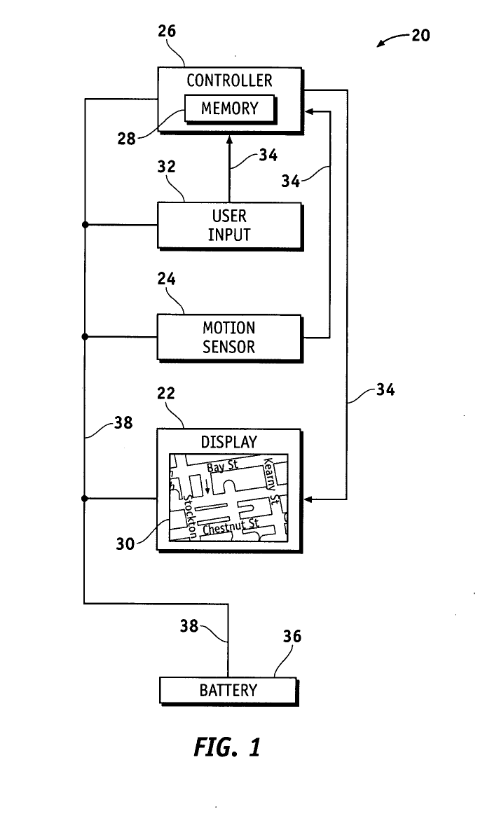

FIG. 1 is block diagram of an exemplary handheld electronic device 20 including a motion-controlled display 22 (e.g., a liquid crystal display). In addition to display 22, handheld electronic device 20 comprises at least one motion sensor 24 and a controller 26 having a memory 28 associated therewith. As will be described in more detail below, memory 28 stores data relating to at least one map that may be displayed, in portions, on display 22 (shown in FIG. 1 at 30). If desired, handheld electronic device 20 may also include at least one user input 32, which may take the form of a group of buttons, a cursor device, a touchpad, or the like. A plurality of communications lines 34 operatively couple controller 26 to the other components of handheld electronic device 20. Power may be supplied by way of battery 36, which is coupled to each component of electronic device 20 via connections 38.

Controller 26 may comprise any processing device suitable for performing the various methods, process, tasks, calculations, and display functions described herein below. In this respect, central controller 26 may comprise (or be associated with) any number of individual microprocessors, navigational equipment, memories, power supplies, storage devices, interface cards, and other standard components known in the art. Furthermore, controller 26 may include or cooperate with any number of software programs (e.g., cartographic map display programs) or instructions.

Motion sensor 24 comprises any device suitable for measuring the movement of handheld electronic device 20, including, for example, various gyroscopes and accelerometers. In a preferred embodiment, motion sensor 24 takes the form of at least one solid state accelerometer; e.g., a circular spring mounted concentrically to a pin or wire that passes freely through the center of the circular spring. When motion sensor 24 experiences any significant amount of motion, the spring deflects and contacts the pin or wire to complete an electrical circuit. When the motion ceases, the surrounding spring returns to its quiescent state wherein the pin or wire is not contacted. Such solid statement accelerometers are well-known in the art and may be particularly desirable for deployment within handheld electronic device 20 due to their modest power requirements.

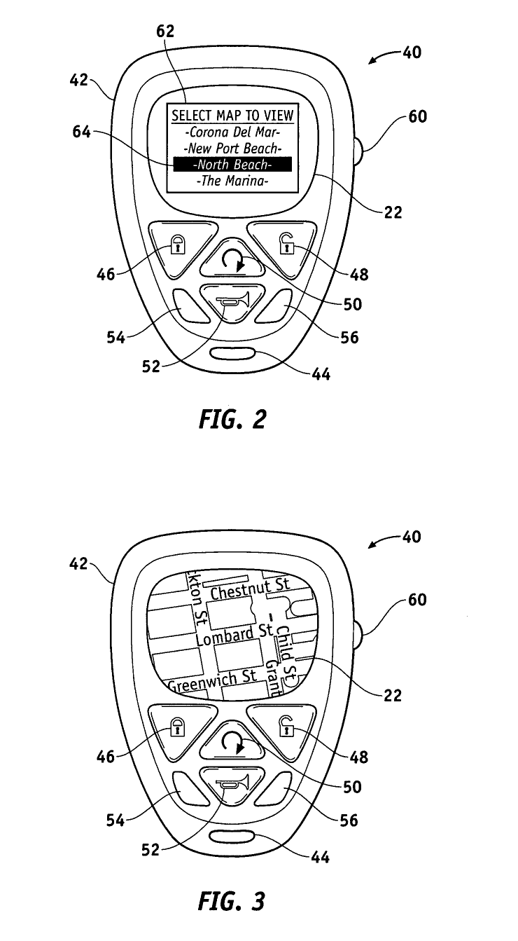

Handheld electronic device 20 may assume a variety of different forms, including, but not limited to, a mobile phone, a digital watch, a digital audio file player (e.g. an MP3 or MP4 player), or a personal digital assistant (PDA). This notwithstanding, display device 20 preferably takes the form of a keyfob, such as that described below in conjunction with FIG. 2. When assuming the form of a keyfob, display device 20 may include one or more additional components beyond those shown in FIG. 1; e.g., a wireless transmitter suitable for transmitting radiofrequency signals to a vehicle indicative of user commands (e.g., UNLOCK DOORS, LOCK DOORS, POP TRUNK, etc.). Such components are standard in the industry and are thus not described in detail herein.

FIGS. 2 and 3 are plan views of a keyfob 40 corresponding to electronic device 20 (FIG. 1). Keyfob 40 comprises a housing 42 having an opening 44 therethrough that enables keyfob 40 to be attached to a keychain in the well known manner. In this case, user input 32 (FIG. 1) comprises a plurality of buttons mounted on the exterior of housing 42. This plurality of buttons may include a LOCK button 46, an UNLOCK button 48, a REMOTE START button 50, a TRUNK UNLOCK button 52, a MOTION CONTROL button 54, and a DISPLAY MAP button 56 (the functions of the latter two buttons will be described below). A scroll wheel 60 may be mounted on a side of housing 42 and utilized to navigate among status information pertaining to the vehicle and displayed on display 22 (e.g., information relating to the vehicle's mileage, tire pressure, current fuel level, radio station settings, door lock status, etc.). A user may rotate scroll wheel 60 to navigate between vehicular features and depress scroll wheel 60 to select a desired feature and view the status information associated therewith.

As noted above, keyfob 20 includes a memory (e.g., memory 28 shown in FIG. 1) suitable for storing data relating to one or more maps. As indicated in FIG. 2, a user may select a desired map from a library of stored maps utilizing a selection menu 62, which may be accessed utilizing DISPLAY MAP button 56. Selection menu 62 may contain a list of text labels representing different maps stored in memory 28. A user may select amongst this list of text labels by, for example, rotating scroll wheel 60 until a text label designating a desired map is highlighted (indicated in FIG. 2 at 64). The user may then depress scroll wheel 60 to select the desired map. As indicated in FIG. 3, controller 26 subsequently generates a portion of the selected map on display 22. The map may include symbology indicative of various types of cartographic information, including the locations of buildings, roadways, and other geographic features. In addition, if keyfob 20 is equipped with a global positioning system (GPS) device or other such position-locating device, the generated map may indicate the position of keyfob 20. This example notwithstanding, it should be appreciated that the manner in which a particular map is selected or recalled will inevitably vary in different embodiments. For example, in certain embodiments, controller 26 may recall a map without undergoing a user-selection process; e.g., if keyfob 20 is equipped with a GPS device or other such position-locating device, controller 26 (FIG. 1) may determine the appropriate map to recall from memory 28 based upon the current location of keyfob 20.

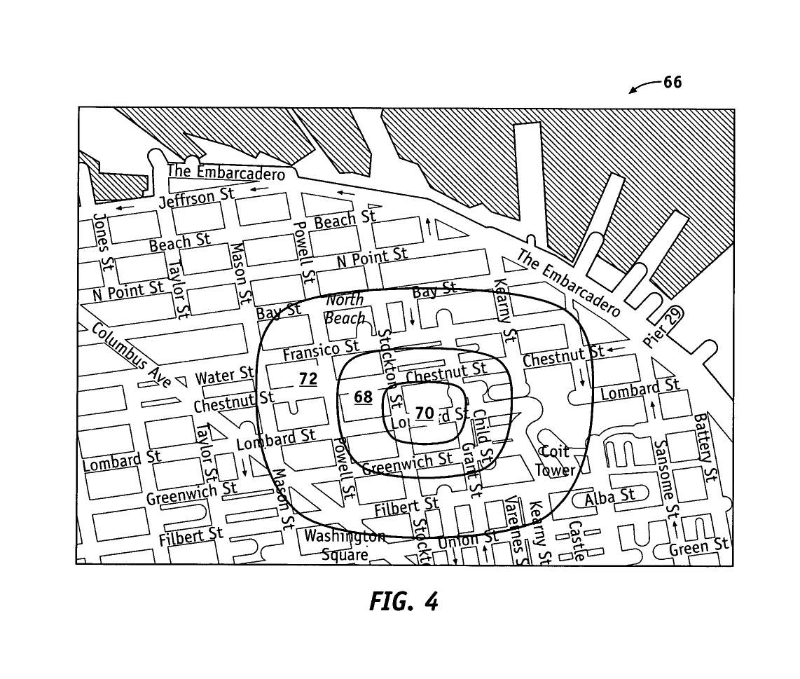

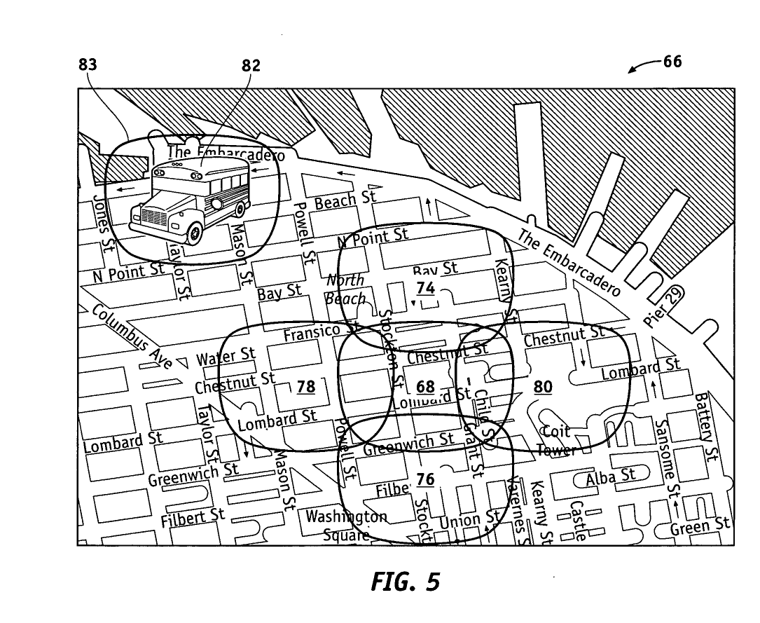

FIGS. 4 and 5 each illustrate a map 66 that may be stored in memory 28 and displayed, in portions, on display 22. When produced on display 22, a displayed map portion will have a particular field of view (FOV) associated therewith. As only a portion of map 66 is shown at a given time, the area displayed within the FOV will generally be less than the total area of map 66. However, the area displayed within the FOV may be varied by adjusting the scale (i.e., zooming in or out) in the well known manner. For example, as indicated in FIG. 4, the area shown in an initial FOV 68 may be decreased by zooming in to a second FOV 70 or, instead, increased by zooming out to a third FOV 72. The area shown in the FOV may also change as the FOV moves within a plane that may be substantially parallel to the plane of map 66 (commonly referred to as “scrolling”). That is, as indicated in FIG. 5, the area shown in initial FOV 68 may be adjusted by scrolling upward to a fourth FOV 74, scrolling downward to a fifth FOV 76, scrolling left to a sixth FOV 78, or scrolling right to a seventh FOV 80.

By adjusting the FOV of the displayed map portion in the manner described above, a user may explore map 66, locate a desired destination, or determine a route of travel. Controller 26 may also be configured to generate icons on display 22 indicative of the locations of points-of-interest (e.g., automated teller machines) on map 66. If desired, such icons may initially be enlarged to facilitate user-location. For example, as shown in FIG. 5, a bus icon 82 designating the general location of a bus stop may be enlarged to increase the probability that a user will come across a portion of icon 82 as he or she adjusts the FOV of the map image to explore map 66. Furthermore, when a user then centers the FOV on bus icon 82 (indicated in FIG. 5 at 83), controller 26 may scale bus icon 82 down so as to reveal the portion of map 66 surrounding the bus stop represented by bus icon 82.

In conventional electronic devices, an externally-mounted user input, such as a cursor device, is typically employed to adjust the FOV of the displayed map portion (e.g., scrolling and zooming). However, as noted above, such externally-mounted user inputs are associated with certain limitations. Thus, in accordance with an exemplary embodiment of the present invention, the following describes different manners in which controller 26 may be configured to adjust the FOV of display 22 in relation to the movement of keyfob 40 (FIG. 2) as detected by motion sensor 24.

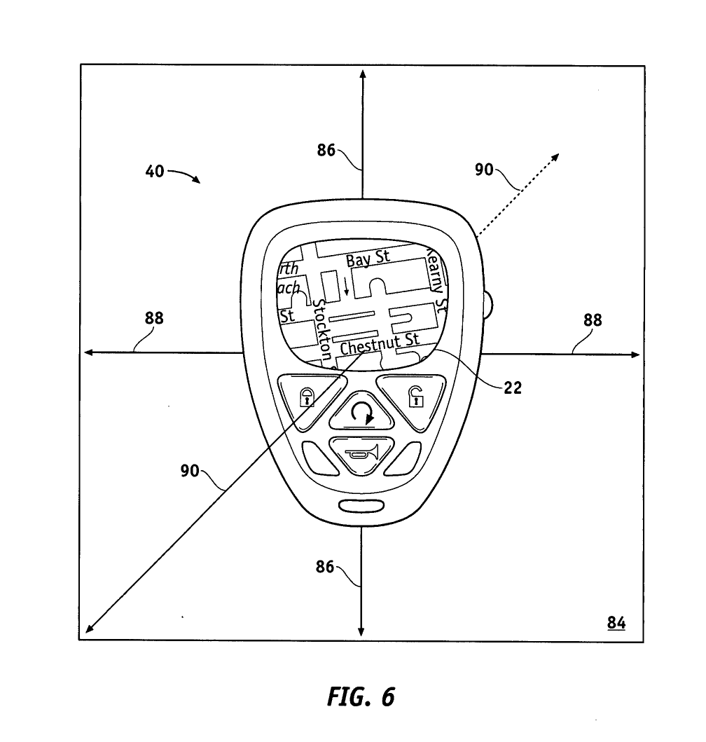

FIG. 6 illustrates a first exemplary manner in which controller 26 may be configured to adjust the FOV of display 22 based upon the movement of keyfob 40 as detected by motion sensor 24. In this particular exemplary embodiment, motion sensor 24 (FIG. 1) of keyfob 40 is configured to measure the movement of keyfob 40 within a first plane 84; i.e., along a longitudinal axis 86 and a first transverse axis 88. If desired, motion sensor 24 may also be configured to measure the movement of keyfob along a second traverse axis 90. Plane 84 may be substantially perpendicular (or parallel) to ground, and second transverse axis 90 may be substantially perpendicular to plane 84; however, it will be appreciated that the orientation of plane 84 and second transverse axis 90 with respect to each other and with respect to ground may vary amongst different embodiments.

In accordance with exemplary embodiment illustrated in FIG. 6, controller 26 (FIG. 1) may adjust the FOV of display 22 (FIG. 2) based upon device movement in the following manner: when motion sensor 24 indicates that keyfob 40 is being moved along longitudinal axis 86 in a first direction (upward in the context of FIG. 6), controller 26 scrolls the FOV of display 22 upward. When motion sensor 24 detects that keyfob 40 is being moved along longitudinal axis 86 in a second opposite direction (downward in the context of FIG. 6), controller 26 scrolls the FOV of display 22 downward. When motion sensor 24 detects that keyfob 40 is being moved along first transverse axis 88 in a first direction (left in the context of FIG. 6), controller 26 scrolls the FOV of display 22 to the left. Finally, when motion sensor 24 indicates that keyfob 40 is being moved along first transverse axis 88 in a second opposite direction (right in the context of FIG. 6), controller 26 scrolls the FOV of display 22 to the right. Thus, referring to map 66 shown in FIG. 5, a user may scroll from FOV 68 to FOV 74, FOV 76, FOV 78, or FOV 80 by moving keyfob 40 upward, downward, to the left, or to the right, respectively.

Controller 26 may also be configured to adjust the scale of the FOV produced on display 22 based upon the movement of keyfob 40 along second transverse axis 90. For example, when motion sensor 24 indicates that keyfob 40 is being moved along second transverse axis 90 in a first direction (toward the viewer in the context of FIG. 6), controller 26 decreases the scale the FOV of display 22 (i.e., zooms out). In contrast, when motion sensor 24 detects that keyfob 40 is being moved along second transverse axis 90 in a second opposite direction (away from the viewer in the context of FIG. 6), controller 26 increases the scale the FOV of display 22 (i.e., zooms in). Thus, referring to map 66 shown in FIG. 4, a user may transition from FOV 68 to FOV 72 or FOV 70 by moving keyfob 40 generally toward or away from the user's body, respectively.

Keyfob 40 has thus been described as being configured such that the FOV of display 22 is altered based upon the movement of keyfob 40 along one or more axes. It may be appreciated that, when keyfob 40 is configured in this manner, a user may eventually reach a limit in his or her range of motion and consequently become unable to move keyfob 40 any further in a particular direction. This may make adjusting the FOV of display 22 more difficult. To address this issue, keyfob 40 may be provided with a user input that, when activated, turns on or turns off the motion-control of display 22. For example, as indicated in FIG. 2, keyfob 40 may include a MOTION CONTROL button 54 that, when depressed, deactivates the motion-control of display 22. Thus, when a user has moved keyfob 40 has, for example, moved keyfob 40 as far away from the user's body as possible, the user may depress MOTION CONTROL button 54 and bring keyfob 40 toward his or her body without adjusting the FOV of display 22. Alternatively, controller 26 maybe configured to adjust the FOV of display 22 in relation to the movement sensed by motion sensor 24 only when MOTION CONTROL button 54 is depressed.

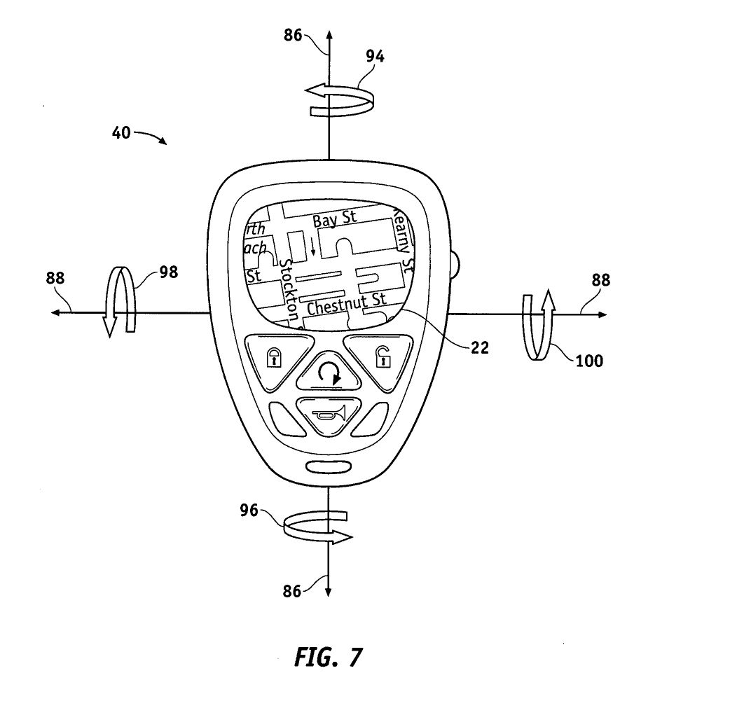

FIG. 7 illustrates a second exemplary manner in which controller 26 may be configured to adjust the FOV of display 22 based upon the movement of keyfob 40, which eliminates the above-noted concerns regarding a user's limited range of motion. In this exemplary case, motion sensor 24 is configured to monitor the rotation movement of keyfob 40 about one or more axes. For example, motion sensor 24 may monitor the rotation of keyfob 40 along longitudinal and transverse axes 86 and 88, respectively. Although, in the illustrated exemplary embodiment, axes 86 and 88 are perpendicular, it should be appreciated that the relative orientation of the axes (or single axis) may be varied as desired.

In the exemplary embodiment illustrated in FIG. 7, controller 26 (FIG. 1) is configured to adjust the FOV of display 22 (FIG. 2) in relation to the movement detected by motion sensor 24 in the following manner: when motion sensor 24 detects that keyfob 40 has been rotated about longitudinal axis 86 in a first direction (indicated by arrow 94), controller 26 may scroll the FOV of display 22 to the right. Thus, referring to FIG. 5, display 22 may transition from FOV 68 to FOV 80. When motion sensor 24 indicates keyfob has been rotated about axis 86 in a second opposite direction (indicated by arrow 96), controller 26 may scroll the FOV of display 22 to the left. Thus, again referring to FIG. 5, display 22 may transition from FOV 68 to FOV 78. When motion sensor 24 indicates keyfob has been rotated about traverse axis 88 in a first direction (indicated by arrow 98), controller 26 may scroll the FOV of display 22 upward. Therefore, in the context of FIG. 5, display 22 may thus transition from FOV 68 to FOV 74. Finally, when motion sensor 24 detects keyfob has been rotated about axis 88 in a second opposite direction (indicated by arrow 100), controller 26 may scroll the FOV of display 22 downward. Display 22 may thus transition from FOV 68 to FOV 76 (FIG. 5).

Motion sensor 24, in conjunction with controller 26, may also be configured to recognize motion speed and acceleration to determine the required distance and speed necessary to acquire a new FOV. That is, the speed and/or acceleration of the movement imparted to the keyfob 40 by the user may be proportional to the virtual distance to the second FOV. In addition, motion sensor 24, in conjunction with controller 26, may be configured to recognize complex motions, such as shaking and knocking. For example, when motion sensor 24 detects a shaking motion, controller 26 may revert to a default mode and clear any icons displayed on the map. In this respect, keyfob 40 may be configured to recognize other complex motions indicative of operational instructions (e.g., moving the keyfob in the shape of the letter “M” to display a map view or in the shape of the letter “S” to display a status menu). As yet another example, keyfob 40 may be configured to recognize a user-specified number by counting successive iterations of a shaking or knocking motion.

In view of the above, it should be appreciated that there has been provided a handheld portable electronic device (e.g., a PDA, a keyfob, etc.) that permits the manipulation of the FOV of a generated map image in a manner that is intuitive and that overcomes the disadvantages associated with externally-mounted controls. Although described above in conjunction with a two-dimensional planform map, it should be understood that other data may be displayed on handheld electronic device and navigated utilizing the above-described motion controls. It should also be understood that a map may be generated in accordance with other types of views, including a three-dimensional perspective view.

While at least one exemplary embodiment has been presented in the foregoing detailed description, it should be appreciated that a vast number of variations exist. It should also be understood that the embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. A handheld electronic device, comprising:
a display;
a memory configured to store a map;
a motion sensor configured to monitor the movement of the handheld electronic device; and
a controller coupled to the display, the memory, and the motion sensor, the controller configured to:
generate an image on the display representative of a portion of the map, the image having a field of view (FOV); and
adjust the FOV of the image based upon the movement of the handheld electronic device as detected by the motion sensor.

2. A handheld electronic device according to claim 1 wherein the motion sensor comprises an accelerometer.

3. A handheld electronic device according to claim 2 wherein the accelerometer is a solid state accelerometer.

4. A handheld electronic device according to claim 1 wherein the motion sensor comprises a gyroscope.

5. A handheld electronic device according to claim 1 wherein the motion sensor is configured to monitor the movement of the handheld electronic device within a first plane.

6. A handheld electronic device according to claim 5 wherein the controller is configured to scroll the FOV based upon the movement of the handheld electronic device within the first plane.

7. A handheld electronic device according to claim 6 wherein the controller is configured to scroll the FOV in substantially the same direction as the handheld electronic device is moved.

8. A handheld electronic device according to claim 6 wherein the motion sensor is further configured to monitor the movement of the handheld electronic device along an axis substantially perpendicular to the first plane.

9. A handheld electronic device according to claim 8 wherein the controller is configured to adjust the scale of the FOV based upon the movement of the handheld electronic device along the axis.

10. A handheld electronic device according to claim 1 wherein the motion sensor is configured to detect the rotational movement of the handheld electronic device.

11. A handheld electronic device according to claim 1 further comprising a user input, the processor coupled to the user input and configured to adjust the FOV of the handheld electronic device only when the user input is activated.

12. A handheld electronic device according to claim 1 further comprising a user input, the processor coupled to the user input and configured to adjust the FOV of the handheld electronic device only when the user input is deactivated.

13. A handheld electronic device, comprising:
a display;
a memory configured to store a map;
a motion sensor configured to monitor the movement of the handheld electronic device with respect to a first axis and a second axis; and
a controller coupled to the display, the memory, and the motion sensor, the controller configured to:
generate a first portion of the map on the display;
transition to a second portion of the map on the display when the motion sensor detects movement of the handheld electronic relative to the first axis; and
transition to a third portion of the map on the display when the motion sensor detects movement of the handheld electronic relative to the second axis.

14. A handheld electronic device according to claim 13 wherein the first axis is a longitudinal axis of the handheld electronic device and the second axis is a first transverse axis of the handheld electronic device.

15. A handheld electronic device according to claim 14 wherein the motion sensor is configured to detect movement of the handheld electronic device along the longitudinal axis and the first transverse axis.

16. A handheld electronic device according to claim 15 wherein the motion sensor is further configured to detect movement of the handheld electronic device along a second transverse axis of the handheld electronic device.

17. A handheld electronic device according to claim 14 wherein the motion sensor is configured to detect rotational movement of the handheld electronic device about the longitudinal axis and the first transverse axis.

18. A keyfob, comprising:
a display;
a memory configured to store a map;
an accelerometer configured to monitor the movement of the keyfob; and
a controller coupled to the display, the memory, and the accelerometer, the controller configured to:
generate an image on the display representative a portion of the map, the image having a field of view (FOV);
scroll the FOV of the image based upon a first type of keyfob movement detected by the accelerometer.

19. A keyfob according to claim 18 wherein the controller is further configured to adjust the scale of the FOV of the image based upon a second type of keyfob movement detected by the accelerometer.

20. A keyfob according to claim 18 wherein the first type of keyfob movement comprises rotational movement about the longitudinal axis of the keyfob.
